(19) United States
(12) Patent Application Publication
(10) Pub. No.: US 2014/0327508 A1
(43) Pub. Date: Nov. 6, 2014

(54) INDUCTOR TUNABLE BY A VARIABLE MAGNETIC FLUX DENSITY COMPONENT

(71) Applicant: QUALCOMM INCORPORATED, San Diego, CA (US)

(72) Inventors: Daeik D. Kim, San Diego, CA (US); Kangho Lee, San Diego, CA (US); David F. Berdy, West Lafayette, IN (US); Mario Francisco Velez, San Diego, CA (US); Jonghae Kim, San Diego, CA (US); Je-Hsiung Lan, San Diego, CA (US); Changhan Yun, San Diego, CA (US); Niranjan Sunil Mudakatte, San Diego, CA (US); Robert P. Mikulka, Oceanside, CA (US)

(73) Assignee: Qualcomm Incorporated, San Diego, CA (US)

(21) Appl. No.: 13/887,633

(22) Filed: May 6, 2013

(51) Int. Cl. H01F 29/14

(52) U.S. Cl. CPC H01F 29/14
USPC 336/105; 716/110

(57) ABSTRACT

An inductor tunable by a variable magnetic flux density component is disclosed. A particular device includes an inductor. The device further includes a variable magnetic flux density component (VMFDC) positioned to influence a magnetic field of the inductor when a current is applied to the inductor.

### I. FIELD

The present disclosure is generally related to inductors that are tunable by variable magnetic flux density components.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. These wireless telephones can include significant computing capabilities.

Electronic devices may use multiple inductors to provide desired functionality. For example, a mobile phone may use an inductor for facilitating an impedance match between a circuit of the mobile phone and an antenna of the mobile phone (e.g., when the mobile phone transmits using a first communication channel). The mobile phone may use a second inductor for facilitating an impedance match between the circuit and the antenna (e.g., when the mobile phone uses a second communication channel). Use of multiple inductors in an electronic device consumes area and increases costs.

### III. SUMMARY

This disclosure presents embodiments of a system that includes an inductor and a variable magnetic flux density component (VMFDC). The VMFDC may control an effective inductance of the inductor, causing the inductor to act as a variable inductance device. The VMFDC may include, for example, controllable magnetic particles or a magnetic array including selectively configurable cells. An electronic device (e.g., a mobile phone) may use fewer inductors to provide desired functionality (e.g., multiple inductance values) compared to a device that uses multiple discrete inductors to provide multiple inductance values. Accordingly, an area used by inductors in the electronic device may be reduced.

In a particular embodiment, a method includes selectively controlling movement of magnetic particles in a sealed enclosure to modify a first magnetic field of an inductor. Modifying the first magnetic field changes an effective inductance of the inductor.

In another particular embodiment, a method includes selectively configuring at least one cell of a magnetic array to control a first magnetic field of an inductor.

In another particular embodiment, a device includes an inductor and a variable magnetic flux density component (VMFDC) positioned to influence a magnetic field of the inductor when a current is applied to the inductor. The VMFDC includes an inductance control component that includes magnetic particles in a sealed enclosure.

In another particular embodiment, a device includes an inductor and a variable magnetic flux density component (VMFDC) positioned to influence a magnetic field of the inductor when a current is applied to the inductor. The VMFDC includes a magnetic array.

In another particular embodiment, a method includes a first step for selectively controlling movement of magnetic particles in a sealed enclosure to modify a magnetic field of an inductor. The method further includes a second step for applying a current to the inductor. The inductor generates the magnetic field in response to the current.

In another particular embodiment, a method includes a first step for configuring at least one cell of a magnetic array to control a magnetic field of an inductor. The method further includes a second step for applying a current to the inductor. The inductor generates the magnetic field in response to the current.

In another particular embodiment, a device includes means for storing energy. The device further includes means for controllably influencing, in response to a control signal, a magnetic field of the means for storing energy when a current is applied to the means for storing energy. The means for controllably influencing includes means for controlling movement of magnetic particles in a sealed enclosure.

In another particular embodiment, a device includes means for storing energy. The device further includes means for controllably influencing, in response to a control signal, a magnetic field of the means for storing energy when a current is applied to the means for storing energy. The means for controllably influencing includes means for controlling a magnetic array.

In another particular embodiment, a non-transitory computer readable medium includes instructions that, when executed by a processor, cause the processor to selectively control movement of magnetic particles in a sealed enclosure to modify a magnetic field of an inductor.

In another particular embodiment, a non-transitory computer readable medium includes instructions that, when executed by a processor, cause the processor to selectively configure at least one cell of a magnetic array to control a magnetic field of an inductor.

In another particular embodiment, a method includes receiving a data file including design information corresponding to a semiconductor device. The method further includes fabricating the semiconductor device according to the design information. The semiconductor device includes an inductor. The semiconductor device further includes a VMFDC positioned to influence a magnetic field of the inductor when a current is applied to the inductor. The VMFDC includes an inductance control component that includes magnetic particles in a sealed enclosure.

In another particular embodiment, a method includes receiving a data file including design information corresponding to a semiconductor device. The method further includes fabricating the semiconductor device according to the design information. The semiconductor device includes an inductor. The semiconductor device further includes a VMFDC positioned to influence a magnetic field of the inductor when a current is applied to the inductor. The VMFDC includes a magnetic array.

One particular advantage provided by at least one of the disclosed embodiments is that a device including an inductor and a variable magnetic flux density component may use fewer inductors to provide desired functionality (e.g., multiple inductance values) compared to a system that uses multiple discrete inductors to provide multiple inductance values. Accordingly, the area used by inductors in the device may be reduced.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a diagram showing a particular embodiment of a structure that includes an inductor and two variable magnetic flux density components;

FIG. 2 is a diagram showing a top view of a particular embodiment of a structure that includes an inductor and an inductance control component, where the inductance control component has a first configuration;

FIG. 3 is a diagram showing a side view of the structure of FIG. 2, where the inductance control component has the first configuration;

FIG. 4 is a diagram showing a side view of the structure of FIG. 2, where the inductance control component has a second configuration;

FIG. 5 is a diagram showing a top view of a particular embodiment of a structure that includes an inductor and a magnetic array, where a first cell has a second configuration;

FIG. 6 is a diagram showing a side view of the structure of FIG. 5, where the first cell has a first configuration;

FIG. 7 is a diagram showing a side view of the structure of FIG. 5, where the first cell has the second configuration;

FIG. 8 is a flow chart of a particular illustrative embodiment of a method of modifying a magnetic field of an inductor;

FIG. 9 is a flow chart of a particular illustrative embodiment of a method of controlling a magnetic field of an inductor;

FIG. 10 is a block diagram of a communication device including an inductor and a variable magnetic flux density component; and

FIG. 11 is a data flow diagram of a particular illustrative embodiment of a manufacturing process to manufacture electronic devices that include an inductor and a variable magnetic flux density component.

### V. DETAILED DESCRIPTION

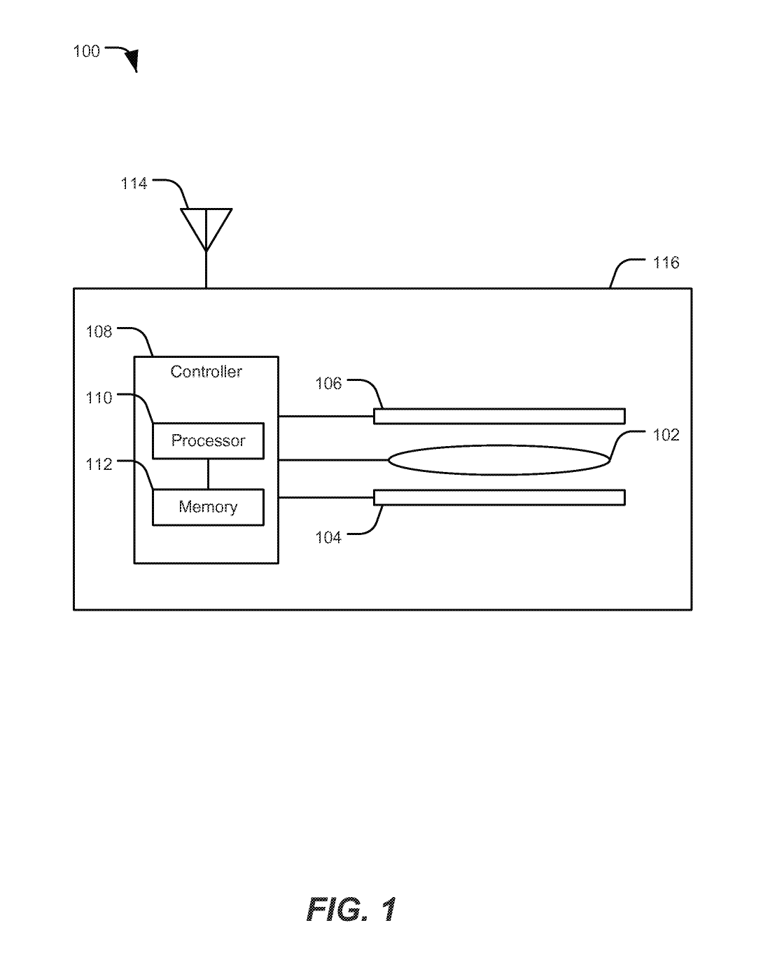

Referring to FIG. 1, a particular illustrative embodiment of a system 100 is shown. The system 100 includes an electronic device 116, an inductor 102 (e.g., a planar spiral inductor or a multilayer power inductor), at least one variable magnetic flux density component (VMFDC) (e.g., a component that may be configured to selectively adjust a magnetic field in response to a control signal) (such as a first VMFDC 104), a controller 108, and an antenna 114. The controller 108 may include a processor 110 connected to a memory 112. The inductor 102 may be used to facilitate an impedance match between the antenna 114 and another circuit or component of the electronic device 116 (such as the controller 108) when the antenna 114 is used to communicate on a particular communication channel. The inductor 102 may be part of a resonant circuit (LC circuit) for a multiband voltage controlled oscillator (VCO) or part of another circuit in a radio frequency (RF) stage of a mobile phone. In a particular embodiment, the inductor 102 is included as part of a circuit board and the at least one VMFDC is coupled or fixed (e.g., fastened using one or more screws) to the circuit board.

In a particular embodiment, the first VMFDC 104 is positioned to influence a magnetic field of the inductor 102 (e.g., a first magnetic field) when a current is applied to the inductor 102. The first VMFDC 104 may be positioned transverse to (e.g., across) the magnetic field of the inductor 102 and may be disposed on a first side of the inductor 102. The first VMFDC 104 may be a component that is capable of affecting a magnetic field by changing an intensity of the magnetic field at a particular location. The processor 110 may be configured to adjust a configuration of the first VMFDC 104 according to instructions received from the memory 112 by applying a control signal to the first VMFDC 104. When the first VMFDC 104 is in a first configuration, the first VMFDC 104 may influence (in a first manner) the magnetic field of the inductor 102, producing a first effective inductance of the inductor 102. When the first VMFDC 104 is in a second configuration, the first VMFDC 104 may influence (in a second manner) the magnetic field of the inductor 102, producing a second effective inductance of the inductor 102. The second effective inductance is different from the first effective inductance. As a result, when the first VMFDC 104 is in the first configuration, the inductor 102 may be used to facilitate an impedance match between the controller 108 and the antenna 114 when the antenna 114 is used to communicate over a first communication channel (e.g., within a first frequency range). When the first VMFDC 104 is in the second configuration, the inductor 102 may be used to facilitate an impedance match between the controller 108 and the antenna 114 when the antenna 114 is used to communicate over a second communication channel (e.g., within a second frequency range that is different from the first frequency range). A smaller inductor may be used in the system 100, as compared to a system that does not use a VMFDC, because the VMFDC may increase the effective inductance of the inductor.

Additional configurations of the first VMFDC 104 may be used to produce additional effective inductance values. The electronic device 116 may also include a second VMFDC 106 positioned to influence the magnetic field of the inductor 102 when current is applied to the inductor 102. The second VMFDC 106 may be positioned transverse to the magnetic field of the inductor 102 and may be disposed on an opposite side of the inductor 102 from the first VMFDC 104. The second VMFDC 106 may be operated in conjunction with the first VMFDC 104 or may be operated separately from the first VMFDC 104. In a particular embodiment, when the second VMFDC 106 is operated in conjunction with the first VMFDC 104, the electronic device 116 may be configured to produce a larger effective inductance from the inductor 102 than the first VMFDC 104 or the second VMFDC 106 would produce by acting separately. Although two VMFDCs (104, 106) are shown in FIG. 1, the electronic device 116 may include one VMFDC or more than two VMFDCs.

In a particular embodiment, one or more inductor parameters may be selected (e.g., by the processor 110). The magnetic field of the inductor 102 may be modified based on the one or more inductor parameters (e.g., in response to a control signal from the processor 110). In a particular embodiment, a circuit (e.g., the controller 108) may be connected to the antenna 114. Influencing the magnetic field of the inductor 102 (e.g., by adjusting a configuration of the first VMFDC 104, the second VMFDC 106, or both) facilitates an impedance match between the antenna 114 and the circuit. In a particular embodiment, the inductor 102 may be used to facilitate an impedance match between the circuit and a plurality of separate antennas. In a particular embodiment, the system 100, or portions of the system 100 (such as the inductor 102, the first VMFDC 104, the second VMFDC 106, or a combination thereof), may be integrated in at least one semiconductor die.

A device that incorporates the system 100 may be configured to use the inductor 102, as a variable inductance inductor, to provide multiple inductance values to one or more circuits of the device (e.g., the controller 108). Thus, the device may use fewer inductors to provide desired functionality (e.g., multiple inductance values), as compared to a system that uses multiple discrete inductors to produce multiple inductance values. Accordingly, an area of the device used by inductors may be reduced. In a particular embodiment, the first VMFDC 104 and the second VMFDC 106 are coupled or fixed to a circuit board that includes the inductor 102. The circuit board may have a reduced area used by inductors, as compared to a circuit board that is not coupled or not fixed to the first VMFDC 102 and to the second VMFDC 104.

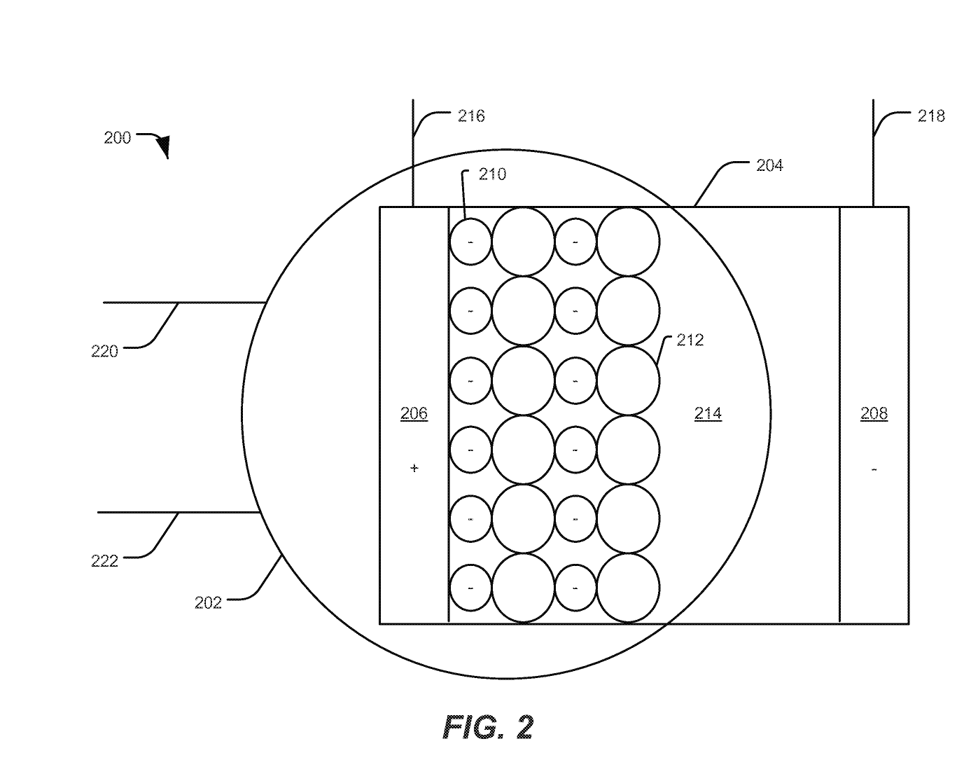

Referring to FIG. 2, a particular illustrative embodiment of a system 200 is shown. The system 200 includes an inductor 202 (e.g., a planar spiral inductor or a multilayer power inductor) and an inductance control component 204. The inductor 202 may correspond to the inductor 102 of FIG. 1. The inductance control component 204 may correspond to the first variable magnetic flux density component (VMFDC) 104 or the second VMFDC 106 of FIG. 1. In a particular embodiment, the inductor 202 is included as part of a circuit board and the inductance control component 204 is coupled or fixed (e.g., fastened using one or more screws) to the circuit board.

In a particular embodiment, the inductor 202 includes a first inductor terminal 220 and a second inductor terminal 222. The first inductor terminal 220 and the second inductor terminal 222 may be used to apply a current to the inductor 202. When a current is applied to the inductor 202, the inductor 202 produces a magnetic field (e.g., a first magnetic field).

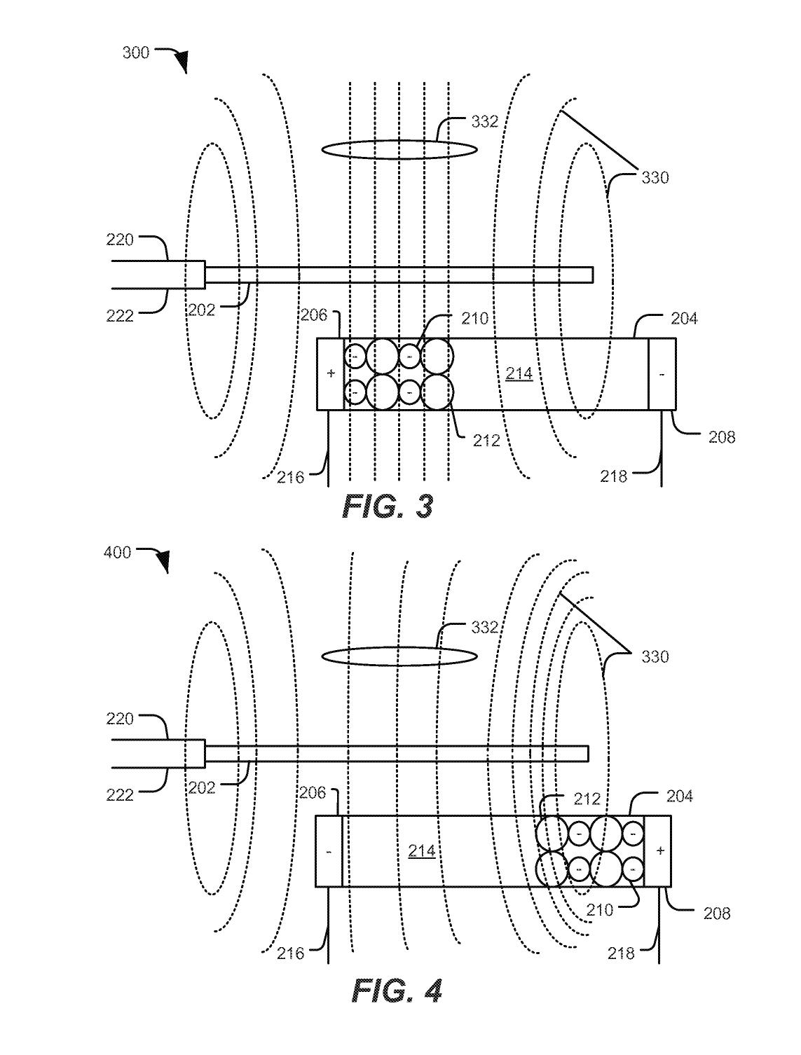

In a particular embodiment, the inductance control component 204 is positioned transverse to (e.g., across) the magnetic field generated by the inductor 202 (as shown in FIGS. 3 and 4). In a particular embodiment, the inductance control component 204 includes a first electrode 206 and a second electrode 208. The inductance control component 204 may further include magnetic particles disposed in a sealed enclosure 214 (e.g., an enclosure that prevents the magnetic particles from leaking out of the enclosure). The magnetic particles may be disposed in a gel or a fluid that enables or allows movement of the magnetic particles. The magnetic particles may be ionized. The magnetic particles may include ionized nanoparticles 210 and shell particles 212. In a particular embodiment, the ionized nanoparticles 210 include a nano-scale Fe₃O₄ core and the shell particles 212 include a SiO₂ shell. The size of the nano-scale Fe₃O₄ core may be about 10 nm or smaller than about 10 nm. The size of the SiO₂ shell may be in a range of about 10 nm to about 100 nm.

In a particular embodiment, a density of the magnetic particles proximate to the inductor 202 is controllable to adjust the magnetic field of the inductor 202. The inductance control component 204 may include the first electrode 206 coupled to a first electrode input 216 and the second electrode 208 coupled to a second electrode input 218. A potential may be applied across the first electrode 206 and the second electrode 208 via the first electrode input 216 and the second electrode input 218. The potential may cause movement of the magnetic particles relative to the electrodes in a direction transverse to the magnetic field of the inductor 202 (e.g., the first magnetic field), causing the magnetic particles to be arranged in a particular configuration (e.g., closer to one electrode than the other electrode).

In a particular embodiment, when the magnetic particles are aligned in a particular configuration, the magnetic particles may be aligned with the magnetic field of the inductor 202 such that the particles act in a manner similar to a ferromagnetic core. A magnetic field density of the magnetic field of the inductor 202 may be concentrated at a location of the magnetic particles to increase an effective inductance of the inductor 202. In a particular embodiment, when the magnetic particles are arranged in a first configuration (e.g., the magnetic particles are arranged near the center of the inductor 202, as shown in FIG. 2), the magnetic particles adjust the magnetic field of the inductor 202 by a first amount. When the magnetic particles are arranged in a second configuration (e.g., the magnetic particles are arranged away from the center of the inductor 202, such as near the second electrode 208, as shown in FIG. 4), the magnetic particles adjust the magnetic field of the inductor 202 by a second amount. The first amount is different from the second amount. When the magnetic field of the inductor 202 is adjusted by the magnetic particles in the first configuration, the inductor 202 may produce a first effective inductance. When the magnetic field of the inductor 202 is adjusted by the magnetic particles in the second configuration, the inductor 202 may produce a second effective inductance that is different from the first effective inductance. The first configuration may have a higher magnetic particle density in a particular area below the inductor 202 and may produce a higher effective inductance than the second configuration. The magnetic particles may be switched between the first configuration and the second configuration by changing the potential applied across the first electrode 206 and the second electrode 208. Other configurations may also be achieved, e.g., by applying no potential across the first electrode 206 and the second electrode 208 or by increasing or decreasing a magnitude of the potential applied across the first electrode 206 and the second electrode 208. The magnetic particles may be small enough to suppress an eddy current in the inductance control component 204. Eddy currents may cause energy to be dissipated as heat in magnetic devices, especially at high frequencies. Thus, a device that uses the magnetic particles may have a lower heat load, as compared to a device that uses larger magnetic particles or a device that uses more closely packed magnetic particles.

Referring to FIG. 3, a particular illustrative embodiment of a system 300 is shown. The system 300 may correspond to the system 200 of FIG. 2 from a side view. When current is applied to the inductor 202, the inductor 202 produces a magnetic field. Magnetic field lines 330 illustrate a shape of the magnetic field and a relative density of the magnetic field of the inductor 202 as adjusted or influenced by the inductance control component 204. The magnetic field lines 330 are not drawn to scale and are used for purposes of illustration. The magnetic field of the inductor 202 may be different from the magnetic field shown in FIG. 3.

In the embodiment illustrated in FIG. 3, the magnetic particles (e.g., the ionized nanoparticles 210 and the shell particles 212) of the inductance control component 204 are arranged in the first configuration. When the magnetic particles are arranged in the first configuration, the magnetic particles adjust or influence the magnetic field of the inductor 202 by a first amount. When the magnetic field of the inductor 202 is adjusted or influenced by the first amount, a magnetic field density may be larger in a particular region 332, as compared to when the magnetic field of the inductor 202 is adjusted by a second amount, as described with respect to FIG. 4.

Referring to FIG. 4, a particular embodiment of a system 400 is shown. The system 400 may correspond to the system 200 of FIG. 2 from a side view, where the inductance control component 204 is in a second configuration. The magnetic field lines 330 may correspond to the magnetic field lines 330 of FIG. 3 and show a shape and a relative density of the magnetic field of the inductor 202 as adjusted or influenced by the inductance control component 204. The magnetic field lines 330 are not drawn to scale and are for purposes of illustration. The magnetic field of the inductor 202 may be different from the magnetic field shown in FIG. 4.

When the magnetic particles are arranged in the second configuration (as in FIG. 4), the magnetic particles adjust or influence the magnetic field of the inductor 202 by the second amount. When the magnetic field of the inductor 202 is adjusted or influenced by the second amount, the magnetic field density may be smaller in the particular region 332 (as compared to when the magnetic field of the inductor 202 is adjusted by the first amount (e.g., as shown by the particular region 332 in FIG. 3)). For example, the magnetic particles may cause the magnetic field lines 330 to bend or to be more concentrated in a direction towards the magnetic particles, as can be seen by comparing the magnetic field lines 330 of FIG. 3 to the magnetic field lines 330 of FIG. 4.

A device that incorporates the systems 200, 300, and 400 of FIGS. 2-4 may be configured to use the inductor 202 as a variable inductance inductor to provide multiple inductance values to one or more circuits of the device. Thus, the device may use fewer inductors to provide desired functionality (e.g., multiple inductance values), as compared to a system that uses multiple discrete fixed value inductors to produce multiple inductance values. Accordingly, an area of the device used by inductors may be reduced.

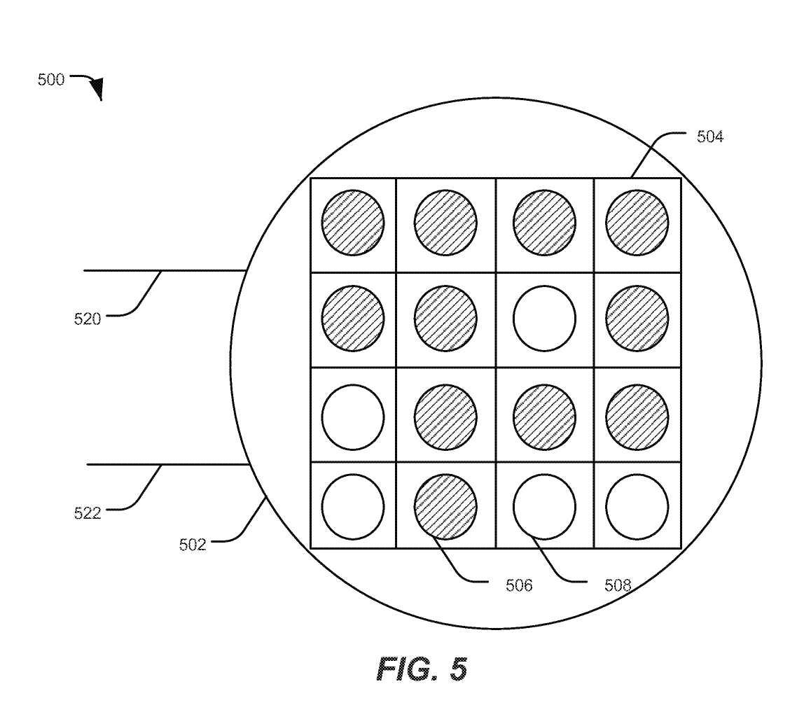

Referring to FIG. 5, a particular illustrative embodiment of a system 500 is shown. The system 500 includes an inductor 502 (e.g., a planar spiral inductor or a multilayer power inductor) and a magnetic array 504. The inductor 502 may correspond to the inductor 102 of FIG. 1. The magnetic array 504 may correspond to the first variable magnetic flux density component (VMFDC) 104 or the second VMFDC 106 of FIG. 1. In a particular embodiment, the inductor 502 is included as part of a circuit board and the magnetic array 504 is coupled or fixed (e.g., fastened using one or more screws) to the circuit board. In another embodiment, the inductor 502 and the magnetic array 504 are disposed on different layers of the same integrated circuit package.

In a particular embodiment, the inductor 502 includes a first inductor terminal 520 and a second inductor terminal 522. The first inductor terminal 520 and the second inductor terminal 522 may be used to apply a current to the inductor 502. When a current is applied to the inductor 502, the inductor 502 may produce a magnetic field (e.g., a first magnetic field).

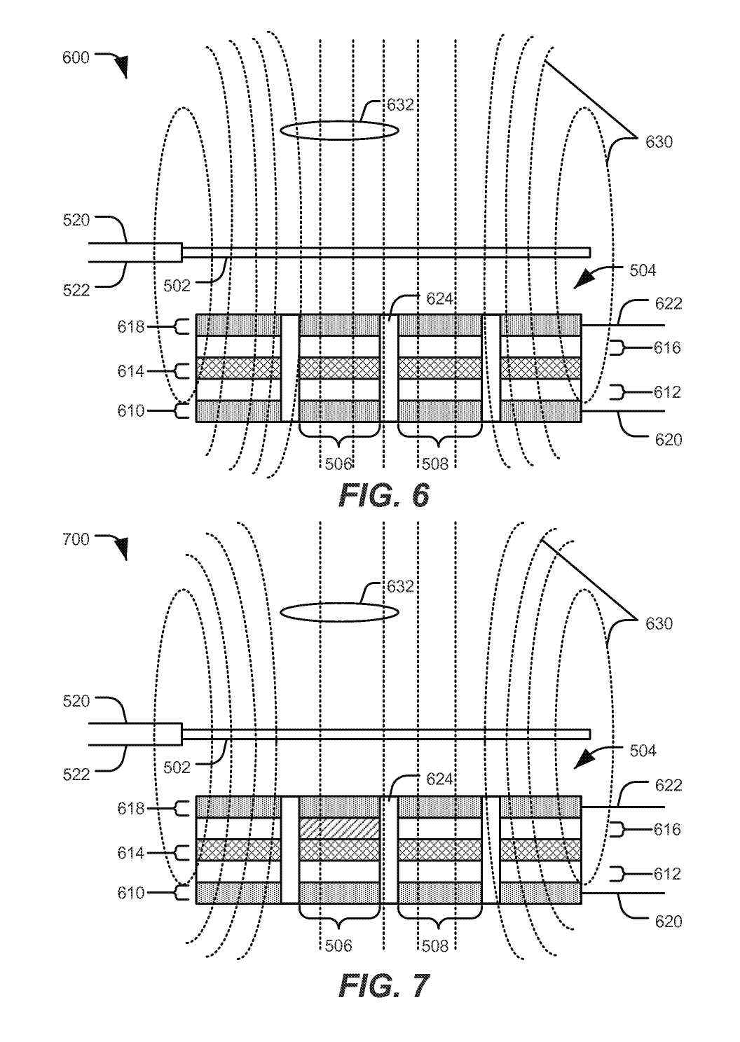

In a particular embodiment, the magnetic array 504 is positioned transverse to (e.g., across) the magnetic field of the inductor 502 (as shown in FIGS. 6 and 7). In a particular embodiment, the magnetic array 504 includes a plurality of cells (e.g., a first cell 506 and a second cell 508). Although sixteen cells are shown in FIG. 5, the system 500 may include more than sixteen cells or fewer than sixteen cells. Each cell of the magnetic array 504 may be configured to be switchable between a first configuration and a second configuration, independently of other cells of the magnetic array 504, based on a current applied to the cell. Each cell of the magnetic array 504 may include a magnetic tunnel junction (MTJ) device. In a particular embodiment, the magnetic array 504 includes a spin transfer torque (STT) magnetoresistive random-access memory (MRAM) array.

When at least one cell (e.g., the second cell 508) of the magnetic array 504 has a first configuration (illustrated in FIG. 5 with no fill), a magnetic field of the at least one cell (e.g., a second magnetic field) may be aligned with the magnetic field of the inductor 502 (e.g., the first magnetic field), and a first aggregate magnetic field of the magnetic array 504 (e.g., a magnetic field of each cell of the magnetic array 504 in aggregate) may adjust or influence the magnetic field of the inductor 502 by a first amount. When at least one cell (e.g., the first cell 506) of the magnetic array 504 has a second configuration (illustrated in FIG. 5 with cross-hatching), a magnetic field of the at least one cell (e.g., a third magnetic field) may be independent of the magnetic field of the inductor 502, and a second aggregate magnetic field of the magnetic array 504 may adjust or influence the magnetic field of the inductor 502 by a second amount. The first amount may be different from the second amount. When the magnetic field of the inductor 502 is adjusted by the first amount, the inductor 502 may produce a first effective inductance. When the magnetic field of the inductor 502 is adjusted by the second amount, the inductor 502 may produce a second effective inductance that is different from the first effective inductance. Any cell of the magnetic array 504 may be configured to have the first configuration or to have the second configuration. Each cell of the magnetic array 504 may be controlled to create a different magnetic moment in at least two different states (e.g., a parallel magnetic state, an anti-parallel magnetic state, and a transition state). The cells of the magnetic array 504 may be controlled to select an effective inductance of the inductor 502.

Referring to FIG. 6, a particular illustrative embodiment of a system 600 is shown. The system 600 may correspond to the system 500 of FIG. 5 from a side view, where the first cell 506 has the first configuration. The cells of the magnetic array 504 shown in FIG. 6 may correspond to one row of cells of the magnetic array 504 of FIG. 5. When current is applied to the inductor 502, the inductor 502 produces a magnetic field. Magnetic field lines 630 shown in FIG. 6 illustrate a shape and a relative density of the magnetic field of the inductor 502 as adjusted or influenced by the magnetic array 504. The magnetic field lines 630 are not drawn to scale and are for purposes of illustration. The magnetic field of the inductor 502 may be different from the magnetic field shown in FIG. 6.

In a particular embodiment, each cell (e.g., the first cell 506 and the second cell 508) of the magnetic array 504 includes a first contact layer 610, a pinned layer 612, a coupling layer 614, a free layer 616, and a second contact layer 618. The pinned layer 612 may include a material with a fixed magnetic field (e.g., NiFe or Co) with respect to the free layer 616. For example, the pinned layer 612 may be constructed on top of an anti-ferromagnetic layer. The pinned layer 612 may be considerably thicker than the free layer 616. The coupling layer 614 may be disposed between the free layer 616 and the pinned layer 612 and may include a conducting non-magnetic material (e.g., MgO). The free layer 616 may include a material that supports an adjustable magnetic field (e.g., NiFe or Co). For example, a magnetization of the free layer 616 of a magnetic tunnel junction (MTJ) cell may be switched between a parallel configuration (e.g., corresponding to a high resistance state of the cell) and an anti-parallel configuration (e.g., corresponding to a low resistance state of the cell). The magnetization of the free layer 616 of a MTJ cell may be switched by providing a polarized spin current to the free layer 616, where the polarized spin current may rotate a local spin of particles in the free layer 616 via exchange coupling. The magnetic array 504 may further include an insulation layer 624 between at least two cells of the magnetic array 504. The insulation layer 624 may inhibit flow of eddy currents between the at least two cells. Eddy currents may cause energy to be dissipated as heat in magnetic devices, especially at high frequencies. Thus, a device that uses the insulation layer 624 may have a lower heat load, as compared to a device that does not use an insulation layer.

The free layer 616 of the cells (e.g., the first cell 506 and the second cell 508) of the magnetic array 504 may have a first unstable state, may have a second stable state, and may have a third stable state. When the free layer 616 of a particular cell has the first unstable state, the particular cell may have the first configuration. When the free layer 616 of the particular cell has the second stable state or has the third stable state, the particular cell may have the second configuration. In a particular embodiment, the magnetic field of the inductor 502 is controllably adjusted or influenced based on the configurations of each of the cells (e.g., the first cell 506 and the second cell 508) of the magnetic array 504.

The first contact layer 610 may be coupled to a first contact input (e.g., the first contact input 620), and the second contact layer 618 may be coupled to a second contact input (e.g., the second contact input 622). Although only the first contact input 620 and the second contact input 622 are shown in FIGS. 6 and 7, an input may be associated with each cell of the magnetic array 504 to enable independent control of each cell of the magnetic array 504. A potential may be applied between the first contact layer 610 and the second contact layer 618 via the first contact input 620 and the second contact input 622. The potential may cause the free layer 616 of the cell to change configuration. Thus, the potential may cause the cell to switch between the first configuration and the second configuration based on a current applied to the cell. For example, at a particular time, a first cell 506 may have a second configuration, as a result of the free layer 616 of the first cell 506 having the second stable state. Subsequently, a potential may be applied across the first contact layer 610 and the second contact layer 618 of the first cell 506, and the free layer 616 may change to a first unstable state, causing the first cell 506 to have the first configuration. If the potential ceases to be applied across the first contact layer 610 and the second contact layer 618 of the first cell 506, the free layer 616 may take on a third stable state, causing the first cell 506 to have the second configuration.

In the embodiment illustrated in FIG. 6, the first cell 506 has the first configuration, as indicated by no fill or cross-hatching in the free layer 616 of the first cell 506. When the first cell 506 has the first configuration, a magnetic field of the first cell 506 (e.g., the second magnetic field) may be aligned with the magnetic field of the inductor 502 (e.g., the first magnetic field) and a first aggregate magnetic field of the magnetic array 504 may adjust or influence the magnetic field of the inductor 502 by a first amount. When the magnetic field of the inductor 502 is adjusted or influenced by the first amount, a magnetic field density of the magnetic field of the inductor may be different in a particular region 632 compared to when the magnetic field of the inductor 502 is adjusted by a second amount, as described with respect to FIG. 7.

Referring to FIG. 7, a particular embodiment of a system 700 is shown. The system 700 may correspond to the system 500 of FIG. 5 from a side view. The cells of the magnetic array 504 shown in FIG. 7 may correspond to one row of cells of FIG. 5. The layers of the magnetic array 504 (e.g., the first contact layer 610, the pinned layer 612, the coupling layer 614, the free layer 616, and the second contact layer 618) may correspond to the layers of the magnetic array 504 of FIG. 6. The magnetic field lines 630 may correspond to the magnetic field lines 630 of FIG. 6 and may show a shape and a relative density of the magnetic field of the inductor 502 as adjusted or influenced by the magnetic array 504. The magnetic field lines 630 are not drawn to scale and are for purposes of illustration. The magnetic field of the inductor 502 may be different from the magnetic field shown in FIG. 7.

In the embodiment illustrated in FIG. 7, the first cell 506 has the second configuration, as indicated by no fill or cross-hatching in the free layer 616 of the first cell 506. When the first cell 506 has the second configuration, a magnetic field of the first cell 506 may be independent of the magnetic field of the inductor 502, and an aggregate magnetic field of the magnetic array 504 may adjust or influence the magnetic field of the inductor 502 by a second amount. When the magnetic field of the inductor 502 is adjusted or influenced by the second amount, a magnetic field density of the magnetic field of the inductor 502 may be smaller in a particular region 632 (as compared to when the magnetic field of the inductor 502 is adjusted or influenced by the first amount (e.g., as shown by the particular region 632 in FIG. 6)). For example, the configuration of the cells of the magnetic array 504 may cause the magnetic field lines 630 to bend or to be more concentrated in a direction away from the cells, as can be seen by comparing the magnetic field lines 630 of FIG. 6 to the magnetic field lines 630 of FIG. 7.

A device that incorporates the systems 500, 600, and 700 of FIGS. 5-7 may be configured to use the inductor 502 as a variable inductance inductor to provide multiple inductance values to one or more circuits of the device. Thus, the device may use fewer inductors to provide desired functionality (e.g., multiple inductance values), as compared to a system that uses multiple discrete fixed value inductors to produce multiple inductance values. Accordingly, an area of the device used by inductors may be reduced.

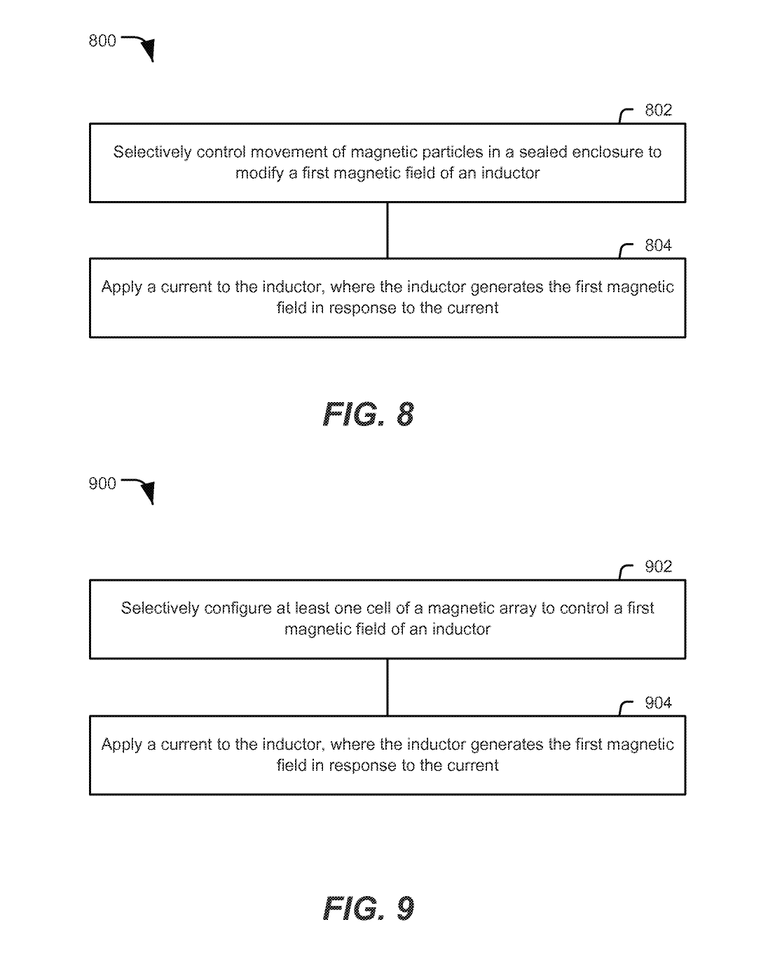

FIG. 8 is a flowchart illustrating a particular embodiment of a method 800 of modifying a magnetic field of an inductor. The method 800 includes, at 802, selectively controlling movement of magnetic particles in a sealed enclosure to modify a first magnetic field of an inductor. For example, as described with reference to FIG. 2, movement of the magnetic particles 210 and 212 of the inductance control component 204 may be selectively controlled (e.g., by application of a control signal to the inductance control component 204) in the sealed enclosure 214 to modify a magnetic field of the inductor 202 (e.g., the first magnetic field).

The method 800 further includes, at 804, applying a current to the inductor, where the inductor generates the first magnetic field in response to the current. For example, a current may be applied via the first inductor terminal 220 and via the second inductor terminal 222 to generate the magnetic field of the inductor 202 (e.g., the first magnetic field).

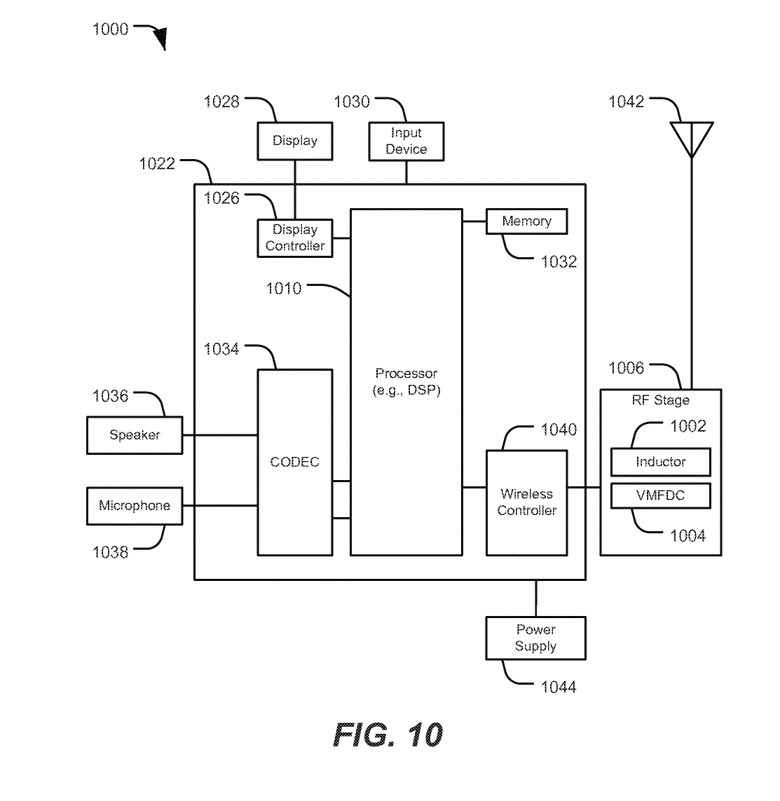

The method of FIG. 8 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method of FIG. 8 can be performed by or can be initiated by a processor that executes instructions, as described with respect to FIGS. 1 and 10.

The method 800 enables a device to use an inductor as a variable inductance inductor to provide multiple inductance values to one or more circuits of the device. Thus, the device may use fewer inductors to provide desired functionality (e.g., multiple inductance values), as compared to a system that uses multiple discrete fixed value inductors to produce multiple inductance values. Accordingly, an area of the device used by inductors may be reduced.

FIG. 9 is a flowchart illustrating a particular embodiment of a method 900 of controlling a magnetic field of an inductor. The method 900 includes, at 902, selectively configuring at least one cell of a magnetic array to control a first magnetic field of an inductor. For example, as described with reference to FIG. 5, the first cell 506 may be selectively configured to have a first configuration or a second configuration (e.g., by application of a control signal to the first cell 506) to modify a magnetic field of the inductor 502 (e.g., the first magnetic field). Other cells of the magnetic array may be controllable independently or as a group.

The method 900 further includes, at 904, applying a current to the inductor, where the inductor generates the first magnetic field in response to the current. For example, a current may be applied via the first inductor terminal 520 and via the second inductor terminal 522 to generate the magnetic field of the inductor 502 (e.g., the first magnetic field).

The method of FIG. 9 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method of FIG. 9 can be performed by or can be initiated by a processor that executes instructions, as described with respect to FIGS. 1 and 10.

The method 900 enables a device to use an inductor as a variable inductance inductor to provide multiple inductance values to one or more circuits of the device. Thus, the device may use fewer inductors to provide desired functionality (e.g., multiple inductance values), as compared to a system that uses multiple discrete value inductors to produce multiple inductance values. Accordingly, an area of the device used by inductors may be reduced.

Referring to FIG. 10, a block diagram of a particular illustrative embodiment of a mobile device that includes an inductor 1002 and a variable magnetic flux density component (VMFDC) 1004 is depicted and generally designated 1000. The mobile device 1000, or components thereof, may include, implement, or be included within a device such as: a mobile station, an access point, a set top box, an entertainment unit, a navigation device, a communications device, a personal digital assistant (PDA), a fixed location data unit, a mobile location data unit, a mobile phone, a cellular phone, a computer, a portable computer, a desktop computer, a tablet, a monitor, a computer monitor, a television, a tuner, a radio, a satellite radio, a music player, a digital music player, a portable music player, a video player, a digital video player, a digital video disc (DVD) player, or a portable digital video player.

The mobile device 1000 may include a processor 1010, such as a digital signal processor (DSP). The processor 1010 may be coupled to a memory 1032 (e.g., a non-transitory computer-readable medium).

FIG. 10 also shows a display controller 1026 that is coupled to the processor 1010 and to a display 1028. A coder/decoder (CODEC) 1034 can also be coupled to the processor 1010. A speaker 1036 and a microphone 1038 can be coupled to the CODEC 1034. A wireless controller 1040 can be coupled to the processor 1010 and can be further coupled to an RF stage 1006 that includes the inductor 1002 and the VMFDC 1004. The RF stage 1006 may be coupled to an antenna 1042. The inductor 1002 and the VMFDC 1004 may reduce an area of a circuit housed within the mobile device 1000 associated with inductors by using the inductor 1002 to provide multiple inductance values to one or more circuits of the mobile device 1000. The inductor 1002 may correspond to the inductor 102 of FIG. 1, the inductor 202 of FIG. 2, or the inductor 502 of FIG. 5. The VMFDC may correspond to the first VMFDC 104 of FIG. 1, the second VMFDC 106 of FIG. 1, the inductance control component 204 of FIG. 2, or the magnetic array 504 of FIG. 5. In other embodiments, the inductor 1002 and the VMFDC 1004 may be included in, or configured to provide multiple inductance values to, other components of the mobile device 1000.

In a particular embodiment, the processor 1010, the display controller 1026, the memory 1032, the CODEC 1034, and the wireless controller 1040 are included in a system-in-package or system-on-chip device 1022. An input device 1030 and a power supply 1044 may be coupled to the system-on-chip device 1022. Moreover, in a particular embodiment, and as illustrated in FIG. 10, the RF stage 1006, the display 1028, the input device 1030, the speaker 1036, the microphone 1038, the antenna 1042, and the power supply 1044 are external to the system-on-chip device 1022. However, each of the display 1028, the input device 1030, the speaker 1036, the microphone 1038, the antenna 1042, and the power supply 1044 can be coupled to a component of the system-on-chip device 1022, such as an interface or a controller. The RF stage 1006 may be included in the system-on-chip device 1022 or may be a separate component.

In conjunction with the described embodiments, a device may include means for storing energy in a magnetic field and means for controllably influencing, in response to a control signal, a magnetic field of the means for storing energy when a current is applied to the means for storing energy. The means for influencing a magnetic field may include means for controlling movement of magnetic particles in a sealed enclosure. The means for storing energy may include the inductor 102 of FIG. 1 or the inductor 202 of FIG. 2. The means for influencing a magnetic field may include the first VMFDC 104 of FIG. 1, the second VMFDC 106 of FIG. 1, the inductance control component 204 of FIG. 2, or a combination thereof.

In conjunction with the described embodiments, a device may include means for storing energy in a magnetic field and means for controllably influencing, in response to a control signal, a magnetic field of the means for storing energy when a current is applied to the means for storing energy. The means for controllably influencing may include means for controlling a magnetic array. The means for storing energy may include the inductor 102 of FIG. 1 or the inductor 502 of FIG. 5. The means for influencing a magnetic field may include the first VMFDC 104 of FIG. 1, the second VMFDC 106 of FIG. 1, the magnetic array 504 of FIG. 5, or a combination thereof.

In conjunction with the described embodiments, a non-transitory computer-readable medium stores instructions that, when executed by a processor, cause the processor to selectively control movement of magnetic particles in a sealed enclosure to modify a magnetic field of an inductor. The non-transitory computer-readable medium may correspond to the memory 112 of FIG. 1 or may correspond to the memory 1032 of FIG. 10. The processor may correspond to the processor 110 of FIG. 1 or may correspond to the processor 1010 of FIG. 10. The magnetic particles may correspond to the magnetic particles 210 and 212 of FIG. 2. The sealed enclosure may correspond to the sealed enclosure 214 of FIG. 2. The inductor may correspond to the inductor 102 of FIG. 1, may correspond to the inductor 202 of FIG. 2, or may correspond to the inductor 1002 of FIG. 10.

In conjunction with the described embodiments, a non-transitory computer-readable medium stores instructions that, when executed by a processor, cause the processor to selectively configure at least one cell of a magnetic array to control a magnetic field of an inductor. The non-transitory computer-readable medium may correspond to the memory 112 of FIG. 1 or may correspond to the memory 1032 of FIG. 10. The processor may correspond to the processor 110 of FIG. 1 or may correspond to the processor 1010 of FIG. 10. The magnetic array may correspond to the magnetic array 504 of FIG. 5. The inductor may correspond to the inductor 102 of FIG. 1, may correspond to the inductor 202 of FIG. 2, or may correspond to the inductor 1002 of FIG. 10.

The foregoing disclosed devices and functionalities may be designed and configured into computer files (e.g. RTL, GDSII, GERBER, etc.) stored on computer-readable media. Some or all such files may be provided to fabrication handlers to fabricate devices based on such files. Resulting products include semiconductor wafers that are then cut into semiconductor dies and packaged into semiconductor chips. The semiconductor chips are then integrated into electronic devices, as described further with reference to FIG. 1.

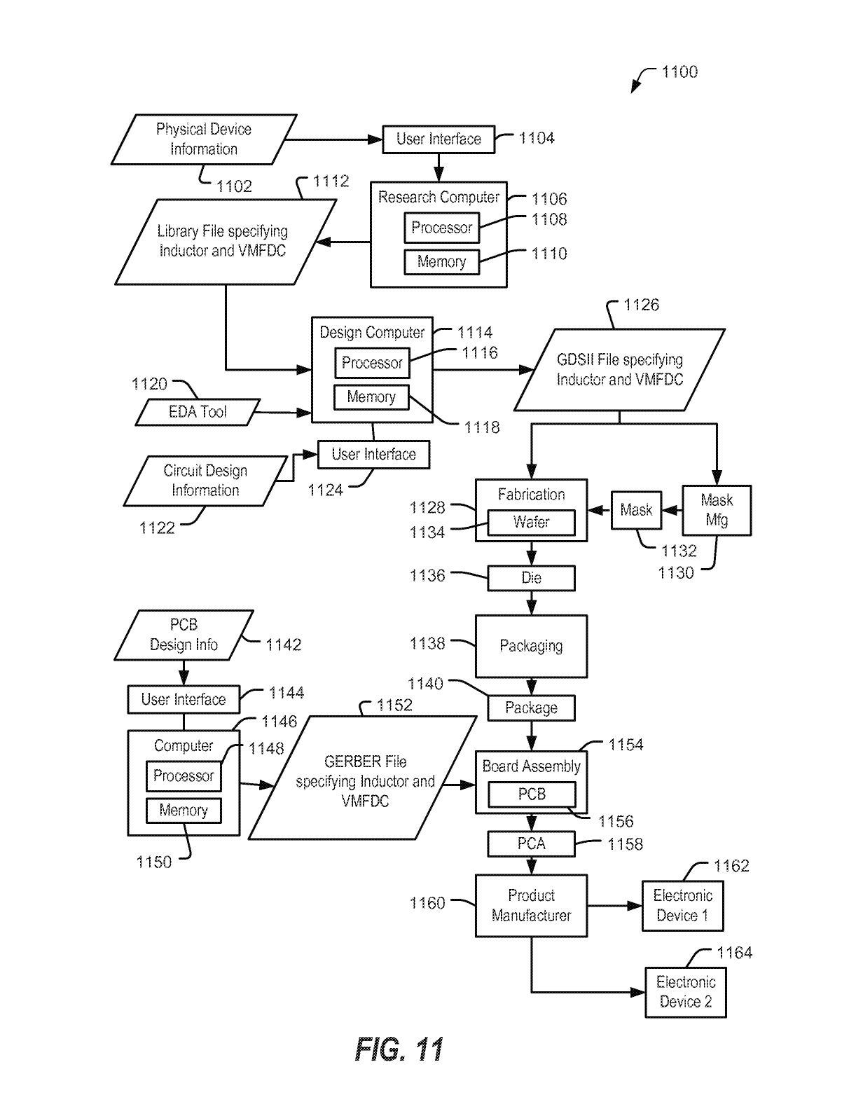

Referring to FIG. 11, a particular illustrative embodiment of an electronic device manufacturing process is depicted and generally designated 1100. In FIG. 11, physical device information 1102 is received at the manufacturing process 1100, such as at a research computer 1106. The physical device information 1102 may include design information representing at least one physical property of a semiconductor device, such as an inductor (e.g., corresponding the inductor 102 of FIG. 1, the inductor 202 of FIG. 2, or the inductor 502 of FIG. 5) and a variable magnetic flux density component (VMFDC) (e.g., corresponding to the first VMFDC 104 of FIG. 1, the second VMFDC 106 of FIG. 1, the inductance control component 204 of FIG. 2, or the magnetic array 504 of FIG. 5). For example, the physical device information 1102 may include physical parameters, material characteristics, and structure information that is entered via a user interface 1104 coupled to the research computer 1106. The research computer 1106 includes a processor 1108, such as one or more processing cores, coupled to a computer-readable medium such as a memory 1110. The memory 1110 may store computer-readable instructions that are executable to cause the processor 1108 to transform the physical device information 1102 to comply with a file format and to generate a library file 1112.

In a particular embodiment, the library file 1112 includes at least one data file including the transformed design information. For example, the library file 1112 may include a library of semiconductor devices, including an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5), provided for use with an electronic design automation (EDA) tool 1120.

The library file 1112 may be used in conjunction with the EDA tool 1120 at a design computer 1114 including a processor 1116, such as one or more processing cores, coupled to a memory 1118. The EDA tool 1120 may be stored as processor executable instructions at the memory 1118 to enable a user of the design computer 1114 to design a circuit including an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5), using the library file 1112. For example, a user of the design computer 1114 may enter circuit design information 1122 via a user interface 1124 coupled to the design computer 1114. The circuit design information 1122 may include design information representing at least one physical property of a semiconductor device, such as an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5). To illustrate, the circuit design property may include identification of particular circuits and relationships to other elements in a circuit design, positioning information, feature size information, interconnection information, or other information representing a physical property of a semiconductor device.

The design computer 1114 may be configured to transform the design information, including the circuit design information 1122, to comply with a file format. To illustrate, the file formation may include a database binary file format representing planar geometric shapes, text labels, and other information about a circuit layout in a hierarchical format, such as a Graphic Data System (GDSII) file format. The design computer 1114 may be configured to generate a data file including the transformed design information, such as a GDSII file 1126 that includes information describing an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5), in addition to other circuits or information. To illustrate, the data file may include information corresponding to a system-on-chip (SOC) that includes an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5), and that also includes additional electronic circuits and components within the SOC.

The GDSII file 1126 may be received at a fabrication process 1128 to manufacture an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5), and according to transformed information in the GDSII file 1126. For example, a device manufacture process may include providing the GDSII file 1126 to a mask manufacturer 1130 to create one or more masks, such as masks to be used with photolithography processing, illustrated in FIG. 11 as a representative mask 1132. The mask 1132 may be used during the fabrication process to generate one or more wafers 1134, which may be tested and separated into dies, such as a representative die 1136. The die 1136 includes a circuit including an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5).

The die 1136 may be provided to a packaging process 1138 where the die 1136 is incorporated into a representative package 1140. For example, the package 1140 may include the single die 1136 or multiple dies, such as a system-in-package (SiP) arrangement. The package 1140 may be configured to conform to one or more standards or specifications, such as Joint Electron Device Engineering Council (JEDEC) standards.

Information regarding the package 1140 may be distributed to various product designers, such as via a component library stored at a computer 1146. The computer 1146 may include a processor 1148, such as one or more processing cores, coupled to a memory 1150. A printed circuit board (PCB) tool may be stored as processor executable instructions at the memory 1150 to process PCB design information 1142 received from a user of the computer 1146 via a user interface 1144. The PCB design information 1142 may include physical positioning information of a packaged semiconductor device on a circuit board, the packaged semiconductor device corresponding to the package 1140 including an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5).

The computer 1146 may be configured to transform the PCB design information 1142 to generate a data file, such as a GERBER file 1152 with data that includes physical positioning information of a packaged semiconductor device on a circuit board, as well as layout of electrical connections such as traces and vias, where the packaged semiconductor device corresponds to the package 1140 including an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5). In other embodiments, the data file generated by the transformed PCB design information may have a format other than a GERBER format.

The GERBER file 1152 may be received at a board assembly process 1154 and used to create PCBs, such as a representative PCB 1156, manufactured in accordance with the design information stored within the GERBER file 1152. For example, the GERBER file 1152 may be uploaded to one or more machines to perform various steps of a PCB production process. The PCB 1156 may be populated with electronic components including the package 1140 to form a representative printed circuit assembly (PCA) 1158.

The PCA 1158 may be received at a product manufacturer 1160 and integrated into one or more electronic devices, such as a first representative electronic device 1162 and a second representative electronic device 1164. As an illustrative, non-limiting example, the first representative electronic device 1162, the second representative electronic device 1164, or both, may be selected from the group of a set top box, a music player, a video player, an entertainment unit, a navigation device, a communications device, a personal digital assistant (PDA), a fixed location data unit, and a computer, into which an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5), are integrated. As another illustrative, non-limiting example, one or more of the electronic devices 1162 and 1164 may be remote units such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof. Although FIG. 11 illustrates remote units according to teachings of the disclosure, the disclosure is not limited to these illustrated units. Embodiments of the disclosure may be suitably employed in any device which includes active integrated circuitry including memory and on-chip circuitry.

A device that includes an inductor (e.g., corresponding the inductor 102 of FIG. 1, the inductor 202 of FIG. 2, or the inductor 502 of FIG. 5) and a VMFDC (e.g., corresponding to the first VMFDC 104 of FIG. 1, the second VMFDC 106 of FIG. 1, the inductance control component 204 of FIG. 2, or the magnetic array 504 of FIG. 5), may be fabricated, processed, and incorporated into an electronic device, as described in the illustrative manufacturing process 1100. One or more aspects of the embodiments disclosed with respect to FIGS. 1-10 may be included at various processing stages, such as within the library file 1112, the GDSII file 1126, and the GERBER file 1152, as well as stored at the memory 1110 of the research computer 1106, the memory 1118 of the design computer 1114, the memory 1150 of the computer 1146, the memory of one or more other computers or processors (not shown) used at the various stages, such as at the board assembly process 1154, and also incorporated into one or more other physical embodiments such as the mask 1132, the die 1136, the package 1140, the PCA 1158, other products such as prototype circuits or devices (not shown), or any combination thereof. Although various representative stages are depicted with reference to FIGS. 1-10, in other embodiments fewer stages may be used or additional stages may be included. Similarly, the process 1100 of FIG. 11 may be performed by a single entity or by one or more entities performing various stages of the manufacturing process 1100.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in memory, such as random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM). The memory may include any form of non-transient storage medium known in the art. An exemplary storage medium (e.g., memory) is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
selectively controlling movement of magnetic particles in a scaled enclosure to modify a first magnetic field of an inductor.

2. The method of claim 1, wherein the magnetic particles are ionized, and wherein the movement of the magnetic particles is controlled by adjusting a potential applied to electrodes of an inductance control component that includes the magnetic particles.

3. The method of claim 2, wherein the electrodes are positioned transverse to the first magnetic field of the inductor.

4. The method of claim 2, wherein the potential causes the magnetic particles to move relative to the electrodes in a direction transverse to the first magnetic field.

5. The method of claim 1,
wherein, when the magnetic particles are arranged in a first configuration, the magnetic particles adjust the first magnetic field by a first amount,
wherein, when the magnetic particles are arranged in a second configuration, the magnetic particles adjust the first magnetic field by a second amount, and
wherein the first amount is different from the second amount.

6. The method of claim 1 wherein selectively controlling movement of the magnetic particles is initiated by a processor integrated into an electronic device.

7. The method of claim 1, further comprising applying a current to the inductor, wherein the inductor generates the first magnetic field in response to the current.

8. The method of claim 1, wherein modifying the first magnetic field modifies an effective inductance of the inductor.

9. The method of claim 1, further comprising:
selecting one or more inductor parameters; and
modifying the first magnetic field based on the one or more inductor parameters,
wherein modifying the first magnetic field facilitates an impedance match between a circuit and an antenna.

10. A method comprising:
selectively configuring at least one cell of a magnetic array to control a first magnetic field of an inductor.

11. The method of claim 10, further comprising applying a current to the inductor, wherein the inductor generates the first magnetic field in response to the current.

12. The method of claim 11,
wherein, when the at least one cell has a first configuration, a second magnetic field of the at least one cell is aligned with the first magnetic field, and
wherein, when the at least one cell has a second configuration, a third magnetic field of the at least one cell is independent of the first magnetic field.

13. The method of claim 11,
wherein, when the at least one cell has a first configuration, a first aggregate magnetic field of the magnetic array adjusts the first magnetic field by a first amount,
wherein, when the at least one cell has a second configuration, a second aggregate magnetic field of the magnetic array adjusts the first magnetic field by a second amount, and
wherein the first amount is different from the second amount.

14. The method of claim 13, wherein the at least one cell includes a free layer and a pinned layer, and the at least one cell has the first configuration or the second configuration based on a state of the free layer.

15. The method of claim 14, wherein, when the at least one cell is in the first configuration, the free layer is in an unstable state, and, when the at least one cell is in the second configuration, the free layer is in a stable state.

16. The method of claim 10, wherein the at least one cell comprises a magnetoresistive random-access memory (MRAM) cell.

17. The method of claim 10, wherein the magnetic array comprises multiple cells, including the at least one cell, arranged transverse to the first magnetic field.

18. The method of claim 10, wherein modifying the first magnetic field modifies an effective inductance of the inductor.

19. The method of claim 10, further comprising:
selecting one or more inductor parameters; and
controlling the first magnetic field based on the one or more inductor parameters,
wherein controlling the first magnetic field facilitates an impedance match between a circuit and an antenna.

20. The method of claim 10, wherein selectively configuring the at least one cell is initiated by a processor integrated into an electronic device.

21. An apparatus comprising:
an inductor; and
a first variable magnetic flux density component positioned to influence a first magnetic field of the inductor when a current is applied to the inductor, wherein the first variable magnetic flux density component comprises an inductance control component comprising magnetic particles in a sealed enclosure.

22. The apparatus of claim 21, wherein the first variable magnetic flux density component is positioned transverse to the first magnetic field.

23. The apparatus of claim 22, wherein the first variable magnetic flux density component is disposed on a first side of the inductor.

24. The apparatus of claim 23, further comprising a second variable magnetic flux density component positioned transverse to the first magnetic field and disposed on an opposite side of the inductor from the first variable magnetic flux density component.

25. The apparatus of claim 21, wherein the magnetic particles are ionized, and wherein the inductance control component comprises electrodes configured to cause movement of the magnetic particles in response to a potential applied across the electrodes.

26. The apparatus of claim 21,
wherein, when the magnetic particles are arranged in a first configuration, the magnetic particles adjust the first magnetic field by a first amount,
wherein, when the magnetic particles are arranged in a second configuration, the magnetic particles adjust the first magnetic field by a second amount, and
wherein the first amount is different from the second amount.

27. The apparatus of claim 21, where at least one of the magnetic particles includes an iron-based compound.

28. The apparatus of claim 27, wherein at least one of the magnetic particles comprises:
a nano-scale Fe₃O₄ core; and
a SiO₂ shell.

29. The apparatus of claim 21, further comprising a controller coupled to the first variable magnetic flux density component, wherein the controller is configured to control an effective inductance of the inductor by applying a control signal to the first variable magnetic flux density component.

30. The apparatus of claim 21, further comprising:
an antenna; and
a circuit coupled to the antenna, wherein influencing the first magnetic field facilitates an impedance match between the antenna and the circuit.

31. The apparatus of claim 30, wherein the first magnetic field is influenced based on a selected inductor parameter.

32. The apparatus of claim 21, integrated in at least one semiconductor die.

33. The apparatus of claim 21, further comprising a device selected from the group of a set top box, a music player, a video player, an entertainment unit, a navigation device, a communications device, a personal digital assistant (PDA), a fixed location data unit, and a computer, into which the inductor and the first variable magnetic flux density component are integrated.

34. An apparatus comprising:
an inductor; and
a first variable magnetic flux density component positioned to influence a first magnetic field of the inductor when a current is applied to the inductor, wherein the first variable magnetic flux density component comprises a magnetic array.

35. The apparatus of claim 34, wherein the first variable magnetic flux density component is positioned transverse to the first magnetic field.

36. The apparatus of claim 35, wherein the first variable magnetic flux density component is disposed on a first side of the inductor.

37. The apparatus of claim 36, further comprising a second variable magnetic flux density component positioned transverse to the first magnetic field and disposed on an opposite side of the inductor from the first variable magnetic flux density component.

38. The apparatus of claim 34, wherein at least one cell of the magnetic array comprises:
a free layer;
a pinned layer; and
a coupling layer disposed between the free layer and the pinned layer.

39. The apparatus of claim 34, wherein each cell of the magnetic array comprises a magnetic tunnel junction (MTJ) device.

40. The apparatus of claim 34, wherein each cell of the magnetic array is configured to be switchable between a first configuration and a second configuration independently of other cells of the magnetic array.

41. The apparatus of claim 34,
wherein, when at least one cell of the magnetic array has a first configuration, a second magnetic field of the at least one cell is aligned with the first magnetic field of the inductor, and
wherein, when the at least one cell has a second configuration, a third magnetic field of the at least one cell is independent of the first magnetic field of the inductor.

42. The apparatus of claim 34,
wherein, when at least one cell of the magnetic array has a first configuration, a first aggregate magnetic field of the magnetic array adjusts the first magnetic field by a first amount,
wherein, when the at least one cell has a second configuration, a second aggregate magnetic field of the magnetic array adjusts the first magnetic field by a second amount, and
wherein the first amount is different from the second amount.

43. The apparatus of claim 34, wherein each cell of the magnetic array is configured to switch between a first configuration and a second configuration based on a current applied to the cell.

44. The apparatus of claim 34, wherein the magnetic array comprises a spin transfer torque (STT) magnetoresistive random-access memory (MRAM) array.

45. The apparatus of claim 34, further comprising an insulation layer between at least two cells of the magnetic array, wherein the insulation layer inhibits flow of eddy currents between the at least two cells.

46. The apparatus of claim 34, further comprising a controller coupled to the first variable magnetic flux density component, wherein the controller is configured to control an effective inductance of the inductor by applying a control signal to the first variable magnetic flux density component.

47. The apparatus of claim 34, further comprising:
an antenna; and
a circuit coupled to the antenna, wherein influencing the first magnetic field facilitates an impedance match between the antenna and the circuit.

48. The apparatus of claim 34, wherein the first magnetic field is influenced based on a selected inductor parameter.

49. The apparatus of claim 34, integrated in at least one semiconductor die.

50. The apparatus of claim 34, further comprising a device selected from the group of a set top box, a music player, a video player, an entertainment unit, a navigation device, a communications device, a personal digital assistant (PDA), a fixed location data unit, and a computer, into which the inductor and the first variable magnetic flux density component are integrated.

51. A method comprising:
a step for selectively controlling movement of magnetic particles in a sealed enclosure to modify a magnetic field of an inductor; and
a step for applying a current to the inductor, wherein the inductor generates the magnetic field in response to the current.

52. The method of claim 51, wherein the step for selectively controlling movement and the step for applying a current are initiated by a processor integrated into an electronic device.

53. A method comprising:
a step for selectively configuring at least one cell of a magnetic array to control a magnetic field of an inductor, and
a step for applying a current to the inductor, wherein the inductor generates the magnetic field in response to the current.

54. The method of claim 53, wherein the step for selectively configuring and the step for applying a current are initiated by a processor integrated into an electronic device.

55. An apparatus comprising:
means for storing energy in a magnetic field; and
means for controllably influencing, in response to a control signal, a magnetic field of the means for storing energy when a current is applied to the means for storing energy, wherein the means for controllably influencing comprises means for controlling movement of magnetic particles in a sealed enclosure.

56. The apparatus of claim 55, integrated in at least one semiconductor die.

57. The apparatus of claim 55, further comprising a device selected from the group of a set top box, a music player, a video player, an entertainment unit, a navigation device, a communications device, a personal digital assistant (PDA), a fixed location data unit, and a computer, into which the means for storing energy and the means for controllably influencing are integrated.

58. An apparatus comprising:
means for storing energy in a magnetic field; and
means for controllably influencing, in response to a control signal, a magnetic field of the means for storing energy when a current is applied to the means for storing energy, wherein the means for controllably influencing comprises means for controlling a magnetic array.

59. The apparatus of claim 58, integrated in at least one semiconductor die.

60. The apparatus of claim 58, further comprising a device selected from the group of a set top box, a music player, a video player, an entertainment unit, a navigation device, a communications device, a personal digital assistant (PDA), a fixed location data unit, and a computer, into which the means for storing energy and the means for controllably influencing are integrated.

61. A non-transitory computer readable medium storing instructions that, when executed by a processor, cause the processor to:
selectively control movement of magnetic particles in a sealed enclosure to modify a magnetic field of an inductor.

62. The non-transitory computer readable medium of claim 61, further comprising a device selected from the group of a set top box, a music player, a video player, an entertainment unit, a navigation device, a communications device, a personal digital assistant (PDA), a fixed location data unit, and a computer, into which the non-transitory computer readable medium is integrated.

63. A non-transitory computer readable medium storing instructions that, when executed by a processor, cause the processor to:
selectively configure at least one cell of a magnetic array to control a magnetic field of an inductor.

64. The non-transitory computer readable medium of claim 63, further comprising a device selected from the group of a set top box, a music player, a video player, an entertainment unit, a navigation device, a communications device, a personal digital assistant (PDA), a fixed location data unit, and a computer, into which the non-transitory computer readable medium is integrated.

65. A method comprising:
receiving a data file including design information corresponding to a semiconductor device; and
fabricating the semiconductor device according to the design information,
wherein the semiconductor device includes:
an inductor, and
a variable magnetic flux density component positioned to influence a magnetic field of the inductor when a current is applied to the inductor, wherein the first variable magnetic flux density component comprises an inductance control component comprising magnetic particles in a sealed enclosure.

66. The method of claim 65, wherein the data file has a GERBER format.

67. The method of claim 65, wherein the data file has a GDSII format.

68. A method comprising:
receiving a data file including design information corresponding to a semiconductor device; and
fabricating the semiconductor device according to the design information,
wherein the semiconductor device includes:
an inductor, and
a variable magnetic flux density component positioned to influence a magnetic field of the inductor when a current is applied to the inductor, wherein the first variable magnetic flux density component comprises a magnetic array.

69. The method of claim 68, wherein the data file has a GERBER format.

70. The method of claim 68, wherein the data file has a GDSII format.
